(19) United States
(12) Patent Application Publication
(10) Pub. No.: US 2003/0151218 A1
(43) Pub. Date: Aug. 14, 2003

(54) Handcart with four wheels and load supporting assembly

(76) Inventor: Steve A. Swaffield, Golden (CA)

Correspondence Address: STEVE A. SWAFFIELD, P.O. BOX 978, GOLDEN, BC, V0A 1H0, CA

(21) Appl. No.: 10/358,919

(22) Filed: Feb. 6, 2003

(30) Foreign Application Priority Data
Feb. 12, 2002 (CA) 2,371,376

(51) Int. Cl. B62B 1/00

(52) U.S. Cl. 280/47.27

(57) ABSTRACT

A four-wheeled handcart used to transport a load under the control of an operator. The four-wheeled handcart is comprised of two main assemblies. The first assembly carries the load and the second assembly supports the load. The load is secured to the carrying assembly which is then tilted rearwards by the operator, using handles extending from the carrying assembly, until the carrying assembly is engaged by the supporting assembly. In this configuration the two assemblies are positively engaged to become an integrated unit which carries and supports the load thus enabling the operator to function solely as the pilot for the handcart.

### BACKGROUND OF THE INVENTION

1. Field of the Invention

This invention is directed to a handcart, and more particularly to a handcart with four wheels and load supporting assembly for transporting a load from point of storage to point of use.

Typically loads are moved using a cart with two wheels. Generally the cart has a platform to stand the load on, a frame to fasten the load to, handles to operate the cart and wheels to move the load. The operator must tilt the load back causing the frame to pivot around the wheel axle mounting point.

In the case of the two-wheeled handcart the operator bears a substantial portion of the load as the cart is tilted back. The operator must continue to bear this load as the cart is moved from point A to point B. This arrangement increases operator fatigue and furthermore increases the possibility of the operator losing control of the load.

2. Prior Art

Typically loads are moved using a cart with two wheels. Canadian patent no. 2138716 is an example of such a cart. In this case the load is a compressed gas cylinder. Generally the cart has a platform to stand the cylinder on, a frame to fasten the cylinder to, handles to operate the cart and wheels to move the load. The operator must tilt the load back causing the frame to pivot over the wheel axle mounting point. As the load is tilted back the operator bears a substantial portion of this load.

Industries using compressed gas cylinders require a method (device) for transporting and fixing cylinders in an upright position to facilitate the use of the gases stored in the cylinders. Compressed gases are stored in steel cylinders at pressures up to 2600 psi. These cylinders also vary in both size and weight. The larger cylinders are the more cumbersome to transport as they weigh up to 250 lbs. Safety is an important issue in the transport and handling of compressed gas cylinders as the possibility of damage to the valves that control the pressure at which the gas is released exists. The accidental knocking off of valves can result in an uncontrolled release of gas, which may result in an explosive, oxidizing or uninhabitable environment, which may result in injury to the operator or bystanders.

As described in Canadian patent no. 2105453 the inventor has allowed for a second pair of swiveling wheels set back in relation to the front wheels of the cart. This arrangement allows the tilted cart to come to a rested position when the rear wheels come in contact with the rolling surface. Furthermore this configuration permits the operator of the cart described in said U.S. Pat No. 2105453 to allow the weight of the cylinder to be carried by the rear wheels.

In the aforementioned invention the design limits the size and structure that can be attached to the cart as the cart must stand upright and remain stable when being loaded or unloaded.

It is therefore provided that a demand for a cart that has the desired property of resting the weight of the load onto the rear wheels thus reducing operator fatigue exists. As well the structure of the cart be designed in such a way as to allow larger rear wheels and also be increasingly stable and maneuverable. As well it is provided that the weight of the support assembly has no bearing in the function of loading and unloading the handcart as the support assembly remains in contact with the rolling surface due to the hinging ability of the cart frame. The cart frame assembly can be released from the support assembly to achieve an upstanding position for loading and unloading operations. The four-wheeled cart can be left unattended in the upstanding position or in the declined, resting position, locked onto the support assembly.

### SUMMARY OF THE INVENTION

The present invention provides a four-wheeled cart for the transportation and support of a load. Thus there is provided a handcart which has a platform to accommodate the load and further a method to secure said load to the cart frame. To support the load and cart in transport there is provided a pair of swiveling rear wheels in trailing position of the front wheels attached to a bracket on the frame of the cart in a hinging relationship. In accordance with supporting the cart frame when tilted back there is provided a continuation of the rear wheel frame assembly which provides a resting area that mates with a corresponding pad located in the frame of the cart so that as the cart frame pivots on the front wheel axle the mating components come together at rest. Further to the resting of the cart on the continuation of the rear wheel frame, there is provided a positive latching mechanism at the mating of the two parts to form an integrated unit.

### BRIEF DESCRIPTION OF THE DRAWINGS

The four-wheeled handcart is described with the function of transporting compressed gas cylinders as an example of a load.

Preferred embodiments of the invention are described in increasing detail and will be better understood when reference is made to the accompanying drawings wherein:

FIG. 1 is a perspective view of the present handcart shown without the cylinder loaded on the cart for clarity.

FIG. 2 is a side view of the handcart in FIG. 1 shown with a cylinder loaded.

FIG. 3 is a side view of the handcart with the cart frame resting on the support assembly.

FIG. 4 is a front view of the handcart with a cylinder loaded and showing the securement.

FIG. 5 is a section view taken at AA of FIG. 4.

FIG. 6 is a rear view of the handcart.

FIG. 7 is a side view of the handcart with front wheels removed for clarity.

FIG. 8 is an enlarged partial side view to show support frame mounting point (hinge) and axle mounting point (cart frame pivot point).

FIG. 9 is a sectional view taken at BB of FIG. 8.

FIG. 10 is an enlarged partial rear view showing mating components of cart frame and support arms of the rest. Also shown is the positive locking mechanism.

FIG. 11 is a sectional view taken at CC showing locking mechanism engaged.

### DETAILED DESCRIPTION OF THE PREFERRED EMBODIMENTS

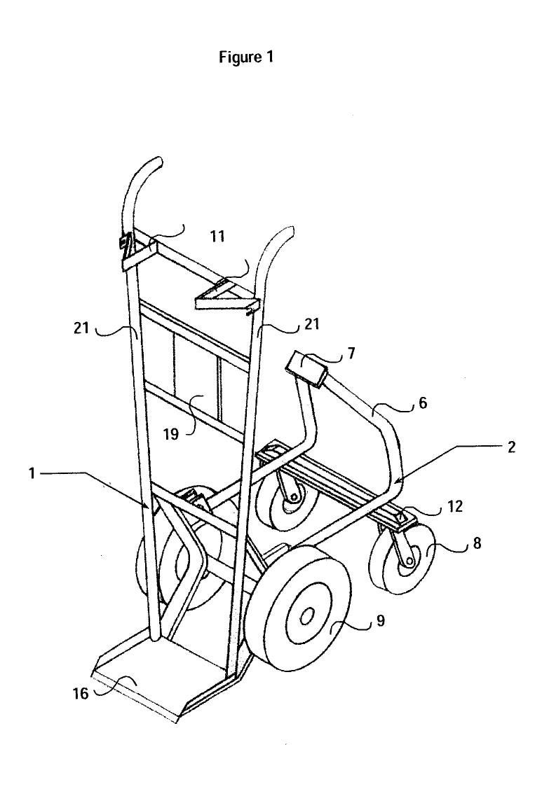

Referring to FIG. 1 the structure of the four-wheeled handcart is constructed using tubular metal, flat metal and angle metal. The metal parts are welded together. However, other materials and joining techniques are contemplated.

With respect to the remaining parts of the four-wheeled handcart, the front wheels 9 are pneumatic, hubbed and mounted on a solid axle. The rear wheels 8 are pneumatic, hubbed, swiveling and bolted to the crossbearer 12 of the support assembly 2. The locking mechanism is a springbolt, also known as a chain bolt.

Referring to FIGS. 1,8 a cart frame assembly 1 comprised of four wheels in accordance with the present invention has a cart frame assembly 1 with the supporting assembly 2 attached to brackets 4 thereto the front axle supports 3. Two pneumatic tires with wheels 9 and axle mounted through axle tube 5, which is, joined to axle tube support brackets 3 to become the front wheels of the cart. Two pneumatic tires and wheels 8 with swiveling ability are attached to crossbearer 12 and become the rear wheels. Crossbearer 12 is the tie beneath the supports 6, which continue upwardly to connect to rest 7.

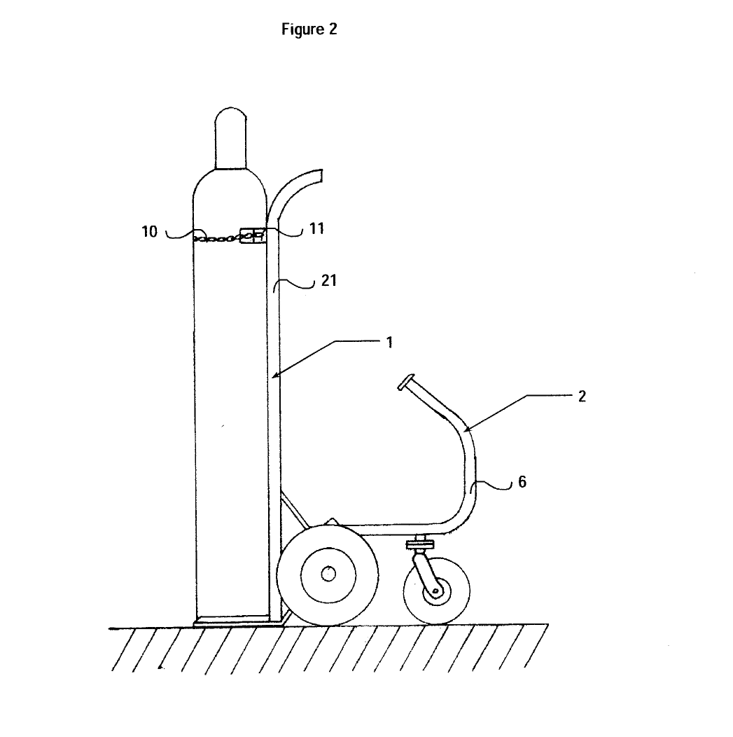

With respect to the handcart having four wheels as illustrated in FIG. 2, there are two distinct groupings. The first such grouping is the cart frame assembly 1, which holds the cylinder. The second grouping is the support assembly 2, which the cart frame is rested upon.

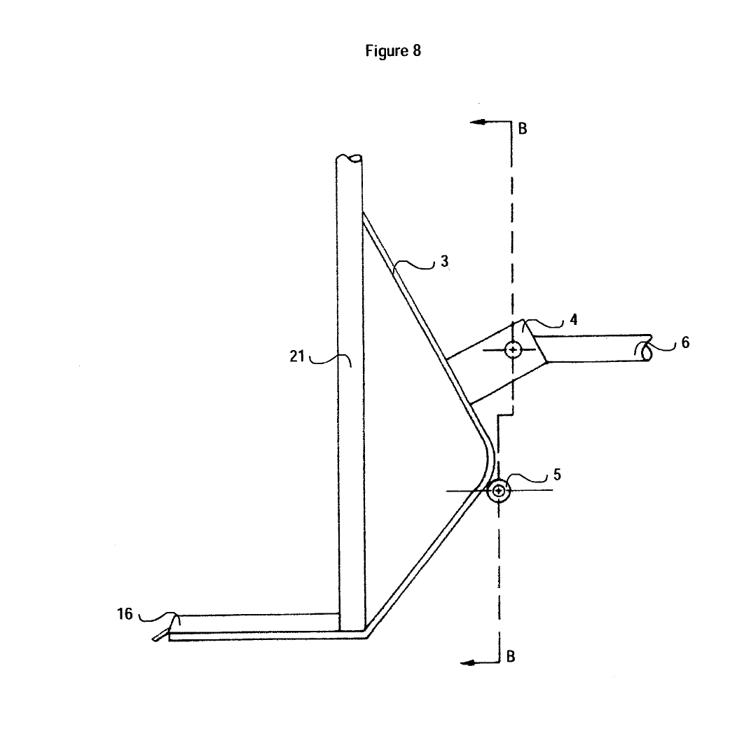

Referring to FIGS. 8,9 the joining point of the aforementioned distinct groupings is the support arm brackets 4 where the support arms 6 are attached to the support arm brackets 4 with pins 15 which said support arm brackets are then joined to the axle tube support brackets 3.

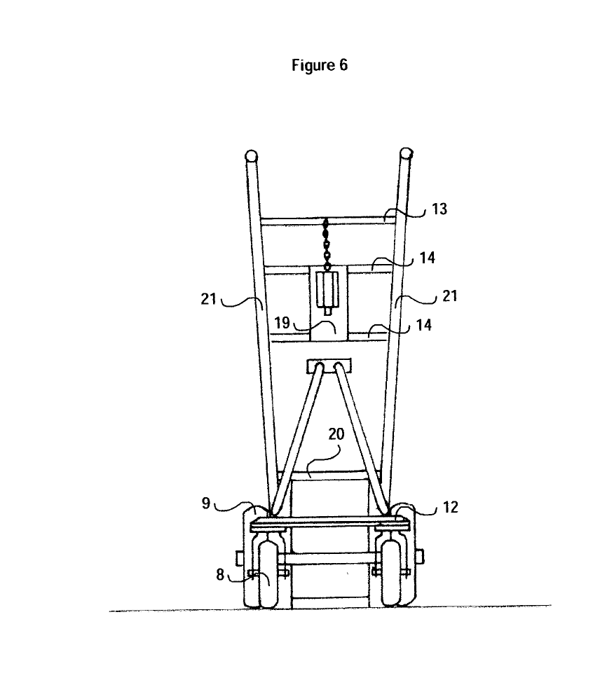

Referring to FIGS. 6,7 the cart frame assembly 1 is comprised of the load support pad 16 and extending upwards two vertical members 21 which curve to the horizontal at their ends to become the handles. Between the two vertical members 21 there are crossties 13, 20 and cart load bearing pad 19, which is joined between two ties 14.

Referring to FIGS. 6,7 the cart supporting assembly 2 is comprised of the cart frame rest 7 and supporting arms 6 and crossbearer 12, which underneath is a pair of swiveling wheels 8 attached.

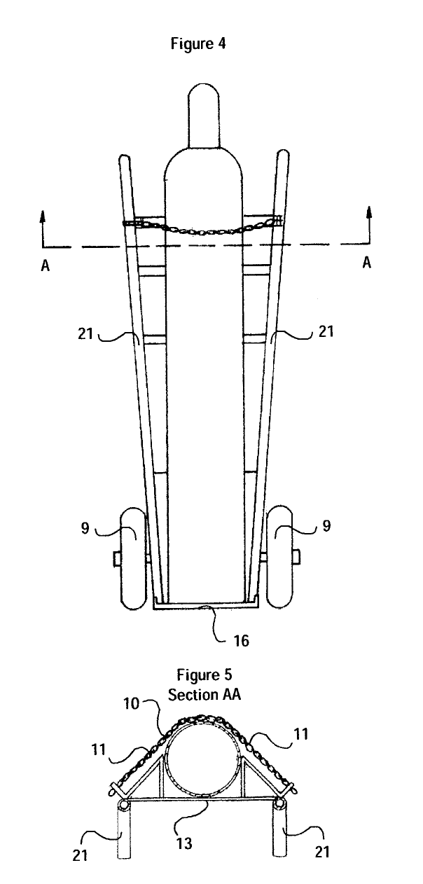

Referring to FIGS. 4,5 to secure the cylinder to the cart frame assembly there is provided the cylinder support pad 16 and lateral support angles 11. A chain 10 is provided for additional security.

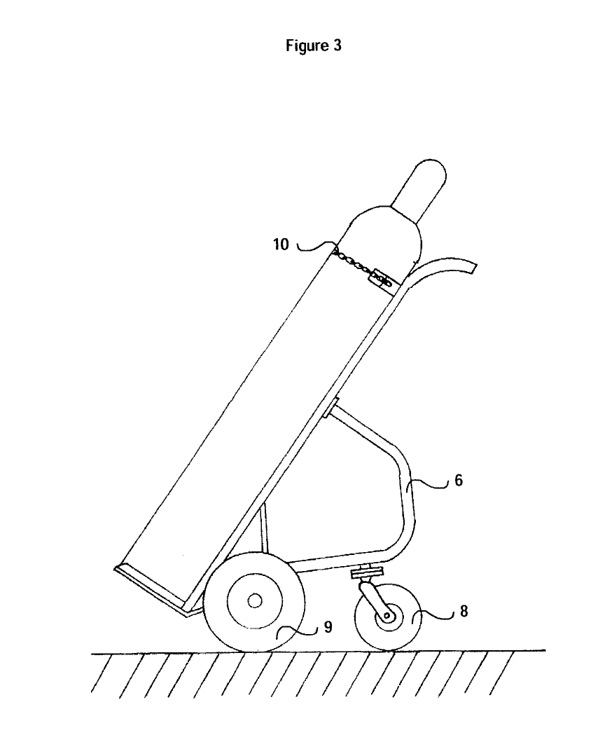

Referring to FIGS. 1,8,9 the cart frame assembly 1 is in a hinging relationship with the cart supporting assembly 2. The aforementioned two assemblies are joined by pinning 15 together to allow free movement of the cart frame assembly 1 as it is declined by the operator. Each of two support arms 6 is attached to support arm brackets 4 on either side with a pin 15 connecting the cart assembly to the support assembly. In this manner the cart frame assembly can be declined from the working or loading, unloading position as shown in FIG. 2 to a resting or transport position as shown in FIG. 3.

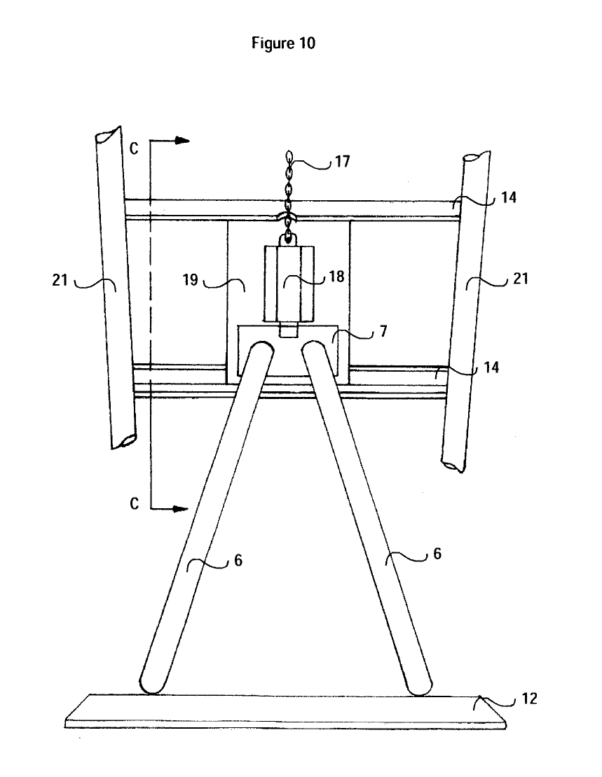

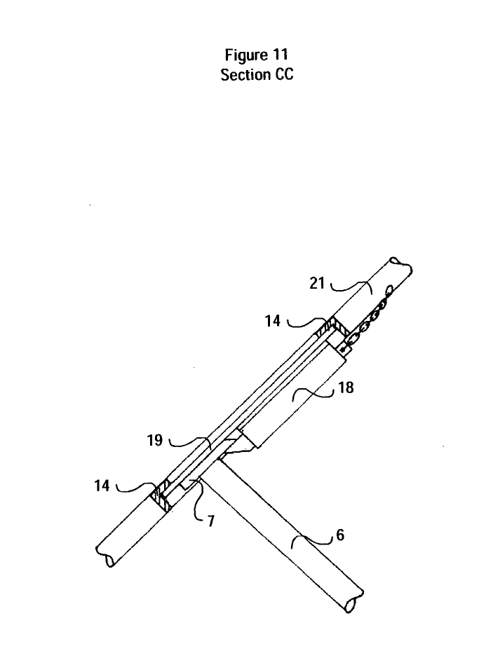

The resting or transport position shown in FIG. 3 consists of a mating area on both the cart frame assembly and the support assembly. This mating area is further detailed in an enlarged view in FIGS. 10 and 11 and further described in the following:

The mating area of the cart frame assembly consists of two frame support crossties 14 and cart frame mating pad 19 and spring bolt 18 and release chain 17. These parts are joined to uprights 21. Release chain 17 is attached at one end to the spring bolt and at the other end to the mid-point of crosstie 13 (see FIG. 6).

The mating area of the support frame assembly consists of resting pad 7 and support arms 6 and crossbearer 12.

When the cart frame assembly and the support assembly join together the latching mechanism is engaged. During transport of the loaded cart (FIG. 3) the latching mechanism (FIGS. 10,11) is automatically engaged and integrates the two assemblies into one unit. The latching mechanism 18 is engaged as the cart assembly is tilted back to rest on the support rest 7. The angle of the bolt on the spring bolt mechanism 18 passes over the angle of the support rest 7 and positively locks the rest to the mating pad 19. When unloading the cart the operator unlatches the spring bolt 18 with release chain 17 and using handle extension of the vertical uprights 21 to tilt the cart forward until the cylinder support pad is in contact with the rolling surface (floor) FIG. 2.

The action of the cart assembly when the operator tilts back the cart is as follows:

The operator tilts back using the handles 21 to bring the cylinder pad off the rolling surface. The cart frame pivots around the axle, which enables the cart frame and cylinder to rise off the floor. The tilting back of the cart frame brings the mating surfaces of the cart frame and support frame into contact. At this position the cart is in a stable posture and the operator need not support the weight of the cylinder or cart. The operator then can undertake transport mode. The operator can direct their efforts to pushing the cart and maneuvering.

The loading and unloading position as seen in FIG. 2 is the position that the operator would remove the securement chain 10 and remove the cylinder from the cart assembly.

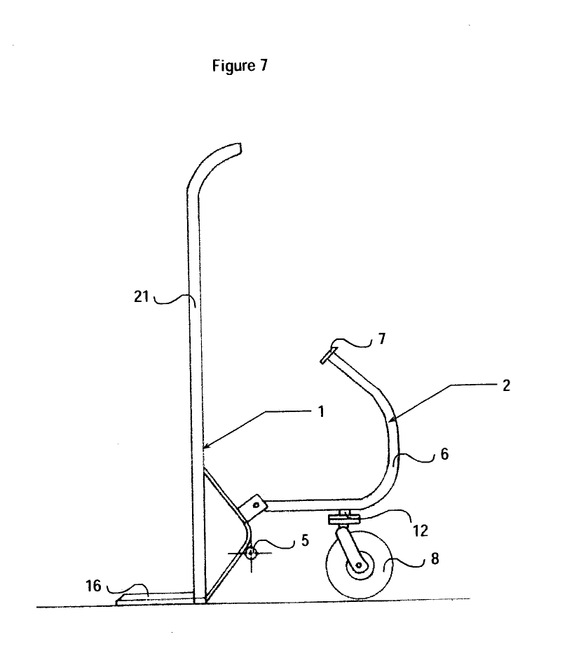

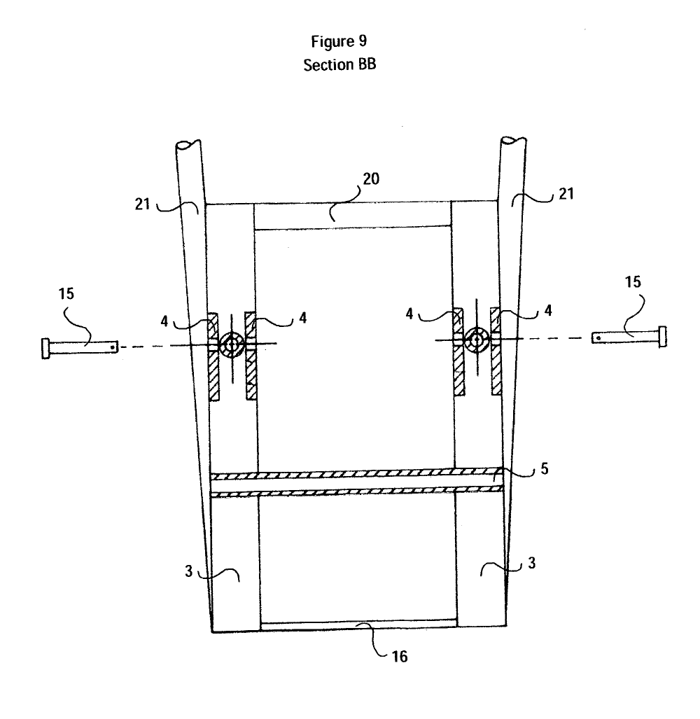

An alternative is contemplated and it will be apparent to those skilled in the design or fabrication trades that the described four wheeled hand cart may be easily modified to accept two cylinders of varying sizes by increasing the lateral components of the single cylinder cart depicted in FIGS. 1-11.

And a further alternative is contemplated for the four wheeled hand cart may be modified to carry loads other than compressed gas cylinders by increasing the size of the support pad 16 the handcart may then carry large and heavy objects such as 45 gallon drums or large boxes.

The above described embodiments of the present invention are intended to be illustrative of the preferred embodiments of the present invention and are not intended to limit in anyway the scope of the present invention. The only limitations to the scope of the present invention are set out in the following appended claims.

### Industrial Applicability

Handcarts are widely used in the transport of compressed gas cylinders, furthermore handcarts are used in the transport of portable oxygen/fuel cutting systems, and further used in materials handling such as the transport of barrels and boxed goods.

The embodiments of the invention in which an exclusive property or privilege is claimed are defined as follows:

1. A handcart for transporting a load from a location on a supporting surface to another location on a supporting surface, said handcart comprising of four wheels, defined as front pair of wheels and rear pair of wheels, said hand cart comprising of a frame for carrying said load, and a supporting frame for supporting said frame for carrying said load, such that said frame for carrying said load is dependent on said supporting frame.

2. The handcart recited in claim 1 wherein the said front wheels are attached to the said frame for carrying.

3. The handcart recited in claim 1 wherein the said rear wheels are attached to the said supporting frame.

4. The handcart recited in claim 1 wherein the said frame for carrying said load is hinged in relation to said supporting frame.

5. The handcart recited in claim 1 wherein the said frame for carrying and the said frame for supporting are equipped with mating pads such that said frame for carrying and said frame for supporting are dependent on each other when said mating pads are in contact with each other.

6. The handcart of claim 5 wherein the said mating pads are active in the apparatus of the said carrying frame, and passive in the apparatus of the said supporting frame.

7. The handcart of claim 6 wherein the said active mating pad is equipped with a positive locking mechanism such as a springbolt.

8. The handcart of claim 6 wherein the said passive mating pad is engaged by the said active mating pad and said positive locking mechanism.

9. The handcart of claim 1 wherein said front pair of wheels are mounted on an axle which is attached to said frame for carrying in such a manner that the said frame for carrying is in a pivoting relation about said front wheels.

10. The handcart of claim 1 wherein the said rear wheels are mounted to the said supporting frame in a swiveling relation to the said front wheels.

11. The handcart of claim 1 wherein the said frame for carrying when pivoted about said front wheels on said axle is limited in the degree of declination by the said supporting frame in such a way that the said load is greatly dependent on the said supporting frame.

12. The apparatus of claim 4 wherein the said supporting frame is attached to the said frame for carrying in a said hinging relationship wherein the said supporting frame is pinned to the frame for carrying by means of brackets mounted to the said frame for carrying in such a way as to provide free movement in a vertically hinging motion and in such a way as to restrict motion laterally to a negligible measurable degree of movement.

13. The apparatus of claim 12 whereas the rear wheels are mounted to the said supporting frame in such a way as to be trailing the said front wheels with a trackwidth nearly as great as the said front wheel trackwidth and said trailing the said front wheels in such a way as to allow 360 degree swiveling movement of said rear wheels required in reversing direction of said hand cart comprising of four wheels.

14. The apparatus of claim 8 wherein the said positively locking mechanism has the ability to be released by the operator of the said handcart.

15. The handcart of claim 1 wherein the said handcart is stable when the said load of said frame for carrying is declined onto said supporting frame.

16. The handcart of claim 1 wherein the said handcart is stable when the center of mass of said load is between the said front wheel axle mounting axis and the said rear wheel mounting axis.

17. A method of adapting a hand cart for moving a load from a location on a supporting surface to another location on said supporting surface, the handcart having a frame which pivots about ground engaging wheels and a load carrying frame said method comprising the characteristics of:
Tilting back said carrying frame with or without load to contact the supporting frame means in such a manner that the said supporting frame assumes the load that the operator would typically carry.
The sole effort of the operator is in the maneuvering and control of said handcart.
